(19) United States
(12) Patent Application Publication
(10) Pub. No.: US 2026/0140247 A1
(43) Pub. Date: May 21, 2026

(54) AWARENESS SENSOR FOR DETERMINING PRECISE SPATIAL COORDINATES OF VARIOUS OBJECTS IN THE VISIBILITY ZONE USING ONE OR MORE SPATIALLY SEPARATED PAIRS OF RECEIVING/TRANSMITTING ANTENNAS

(71) Applicant: RVS Lab Co., Ltd., Seongnam-si (KR)

(72) Inventors: Maxim GURIANOV, Zelenograd (RU); Johngho PARK, Seoul (KR)

(21) Appl. No.: 18/951,285

(22) Filed: Nov. 18, 2024

(51) Int. Cl. G01S 13/06; G01S 13/931

(52) U.S. Cl. CPC G01S 13/06; G01S 13/931

(57) ABSTRACT

Systems, devices, methods, and instructions for determining the spatial coordinates of an object in the visibility zone using a radar device with one or more spatially separated pairs of transmitting and receiving antennas, including receiving at least one dataset from at least one radar sensor, including an object response and coordinates of at least one pair of transmitting and receiving antennas, calculating one or more address trajectories for spatially distributed points that form a grid in relative coordinates, and comparing frames sequential or synchronously received from one or more radar sensors to determine the coordinates of the object.

### FIELD OF THE INVENTION

The embodiments of the present invention generally relate to radar, and in particular to systems, devices, methods and instructions for determining the location of one or more observed objects in the visibility zone (e.g., line of sight) using one or more spatially separated pairs of receiving/transmitting antennas.

### DISCUSSION OF THE RELATED ART

Current radar systems provide a radar range finder on a rotary support device and a radar device based on multiple-input and multiple-output (“MIMO”) technology. MIMO technology, as applied to environmental sensors (e.g., MIMO sensors), emit signals and receive echo signals. The radar sensor device independently transmits signals via several transmitting antennas and independently receives echo signals via several receiving antennas.

The signals received by each receiving antenna from respective transmitting antenna form pairs. The data of each pair is processed separately from each other. In each pair, the geometric arrangement of the receiving and transmitting antennas is unique, which allows each pair to be considered as a separate “virtual antenna.” Together, the virtual antennas form a virtual antenna array (i.e., a phased array antenna or “PAA”).

Devices based on MIMO technology are widely used in environmental control systems, such as when solving the problem of detecting obstacles around a moving platform (e.g., a carrier) on which they are installed. For example, the devices based on MIMO technology may be used for autonomous navigation systems of unmanned vehicles. In another example, the devices based on MIMO technology may be used for vehicles of various levels of autonomy, including in cars.

There are several problems associated with current use of radar sensors. The main disadvantages of the solutions based on radar sensors include the high level of noise caused by multipath interference. This problem is widely known and is a relevant problem for all radar systems, including communication systems and radars as well as those using MIMO technology. Multipath interference results in the device recording, within each individual measurement cycle, both distances to real obstacles and signals caused by random superposition of secondary echo signals.

Combating interference noise is a current area of research and the specific method of combating it may differ in each individual device. A common method of widely known techniques is that they aggregate the results of several measurements at different points in time or in different positions of the sensor. However, a general solution to the problem is still lacking.

Another problem with MIMO-based sensors and other similar radar sensors is that the position of an obstacle is determined in one measurement cycle by analyzing and comparing signals (i.e., echo responses) received from different directions on the device. The accuracy of determining the angular coordinates of a detected target is determined by the accuracy of the approach or method used to calculate such an angle.

Methods based on physical rotation of the sensor in the direction of the target are used in many devices. This approach is used by light detection and ranging (“LIDAR”) systems which utilize a mechanically movable mirror in the sensor as well as radars which utilize a movable antenna mounted on a mechanical rotating device.

The MIMO method for forming a virtual antenna is limited by the physical size (i.e., aperture) of its sensor and has limited accuracy in determining the direction to an obstacle. The synthetic-aperture radar (“SAR”) method is used in radars-a method of synthesizing a large virtual antenna to obtain any required angular resolution. The SAR method allows decimeter spatial resolution to be obtained on the ground from virtually any distance. It is this technology that is used in earth remote sensing radars installed on spacecraft and ensures their operation at a distance of about 1,000 km to the target.

However, the application of SAR technology in autonomous driving applications is limited because SAR technology requires a long observation time and has an inherent delay before receiving data. SAR technology is not currently used in commercial (i.e., publicly available) real-time monitoring devices, including vehicles equipped with driver assistance technologies.

### SUMMARY OF THE INVENTION

Accordingly, the present invention is directed to systems, devices, methods and instructions for determining the location of one or more observed objects that substantially obviate one or more problems due to limitations and disadvantages of the related art.

The embodiments of the present invention provide systems, devices, methods and instructions for determining the location of one or more observed objects in the visibility zone (e.g., line of sight) using one or more spatially separated pairs of receiving/transmitting antennas. In some embodiments, this is achieved by comparing two or more datasets in one coordinate system, obtained from one or more pairs of receiving/transmitting antenna devices spaced apart with a known location.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the systems, devices, methods and instructions for determining the location of one or more observed objects includes systems, devices, methods and instructions for determining the spatial coordinates of an object in the visibility zone using a radar device with one or more spatially separated pairs of transmitting and receiving antennas, including receiving at least one dataset from at least one radar sensor, including an object response and coordinates of at least one pair of transmitting and receiving antennas, calculating one or more address trajectories for spatially distributed points that form a grid in relative coordinates, and comparing frames sequential or synchronously received from one or more radar sensors to determine the coordinates of the object.

In another aspect, additionally or in combination with the other aspects, the embodiments are executed in real-time and/or continually and/or periodically. In another aspect, additionally or in combination with the other aspects, the data from the at least one radar sensor is stored in memory, and retrieved thereafter. In another aspect, additionally or in combination with the other aspects, the data from the at least one radar sensor is received in the form of a set of recorded analog-to-digital converted (“ADC”) data. In another aspect, additionally or in combination with the other aspects, the data from the sensors contains information not only about the coordinates, but also about the speed of movement of the object and/or the platform. In another aspect, additionally or in combination with the other aspects, the radar sensors are movable relative to each other during system operation. In another aspect, additionally or in combination with the other aspects, the address trajectories are obtained in the form of formulas. In another aspect, additionally or in combination with the other aspects, instead of an obstacle map, a probability map of target detection is stored in the memory. In another aspect, the sensor data is used to obtain odometry data when there are no other sources of information in the system. In another aspect, additionally or in combination with the other aspects, instead of a discrete predictive frame, a heat map is used, on which, instead of points, the probability of finding an object at each point is determined. In another aspect, additionally or in combination with the other aspects, separate systems based on MIMO radars are used as radar sensors. In another aspect, additionally or in combination with the other aspects, instead of radar sensors, one or more sensors are replaceable with sensors that receive the same information, but using other physical principles, such as LIDAR, Sonar, video cameras, thermal cameras, and/or stereo pairs of various types.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates a block diagram of the awareness sensor.

FIG. 2 illustrates an example method for determining the precise spatial coordinates of various objects in the visibility zone using a radar device with one or more spatially separated pairs of transmitting and receiving antennas.

FIG. 3 illustrates an example of the installation diagram of an awareness sensor with two radar sensors on a vehicle.

FIG. 4 illustrates a schematic illustration of a coordinate system called a map and variant arrangements of grid nodes on it. In particular, FIG. 4(a), illustrates use of a uniform grid; and FIG. 4(b) illustrates use of a non-uniform grid in a polar coordinate system.

FIG. 5 illustrates a relationship between the frames, predictive frames and address trajectories generated during the operation.

FIG. 6 illustrates sensor data obtained from one sensor and the result of forming a frame from the sensor data.

FIG. 7 illustrates an example of combining frame data and grid data in the process of generating a global map.

### DETAILED DESCRIPTION OF THE EXAMPLE EMBODIMENTS

Reference will now be made in detail to the embodiments of the present invention, examples of which are illustrated in the accompanying drawings.

The embodiments of the present invention may provide systems, devices, methods and instructions for determining the location of one or more observed objects in the visibility zone (e.g., line of sight) using one or more spatially separated pairs of receiving/transmitting antennas. In some embodiments, this may be achieved by comparing two or more datasets in one coordinate system, obtained from one or more pairs of receiving/transmitting antenna devices spaced apart with a known location.

An example use case of the embodiments will now be described. At the outset, a system of terrain coordinates may be generated in a device memory, in the coordinates of which the location of objects may be calculated. Such a coordinate system is called a “map.” A “grid” is applied to the map-a set of abstract points located at a certain step on the map. The grid step may determine the accuracy of determining the coordinates of objects and the volume of calculations.

In an iterative method, each iteration may be assigned a serial number. At the beginning of each iteration, each radar device may collect data about the surrounding space (e.g., within a line of sight). The data in the aggregate may include information about one coordinate (i.e., range to an object) or several coordinates (i.e., range to one or more objects and its angular coordinates) to each detected obstacle.

If the device generates only one coordinate information (e.g., range to the target), then the operation may utilize at least two devices and precise knowledge of their mutual spatial arrangement on the platform. If the device generates two or more coordinate information (e.g., range, angle, etc. to the target), then at least one radar sensor may be sufficient for the invention to operate.

For each set of data obtained in the previous step, a “frame” may be formed. Here, the coordinates of each device on the map may be recorded for this device, using data on the platform's movement. For each set of data on the grid, a subset of points (i.e., grid nodes) may be selected in which, according to the device data, an obstacle may be located. The set of such subsets, as well as information on the exact coordinates of the device, together may constitute a “frame.”

Based on the data on the carrier's movement at each step for the entire grid and for each device, “predictive frames” may be generated, which contain a model of the frame received by the radar sensor in a situation where an obstacle is present at each individual grid node. The set of predictive frames for each grid node may be expressed as a discrete or continuous function of the coordinates of each obstacle separately from time (or the step number of the iteration). Here, it is called an “address trajectory.”

The obtained “frames” and the obtained “predictive frames” may be compared by means of a correlation function and, based on the data from previous iterations, each grid node may be assigned a statistical probability of finding an object at these coordinates.

After conducting at least two iterations and when the probability of detecting an object exceeds a reliability threshold (e.g., P=0.95), the corresponding grid node may be considered a detected obstacle, and the corresponding address trajectory may be stored as an address trajectory that contains an obstacle. In subsequent frames, a signal may be also expected to be received from this address trajectory in frames from radar devices. To reduce the computational complexity, the address trajectory containing the obstacle may be excluded from further checks. The result at each iteration may be a grid with the detected objects marked on it.

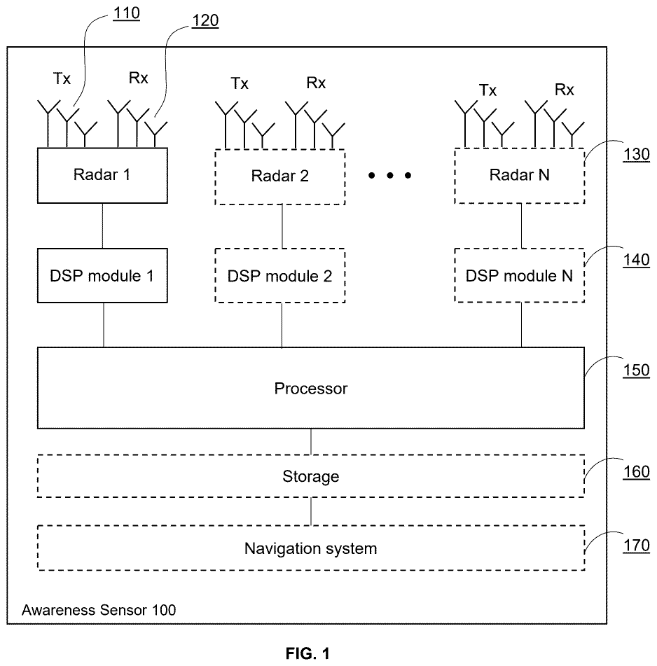

FIG. 1 illustrates a block diagram of the awareness sensor 100. As illustrated in FIG. 1, awareness sensor (100) may include one or more pairs of transmit/receive antennas (110 and 120) connected to one or more radar sensors (130). The number of antennas and radars used may be determined by the desired size and shape of the field of view (FoV) of the device. For example, for a car, it may be sufficient to use two radars with a general antenna array consisting of 2 or 3 transmitting antennas and 2 or 4 receiving antennas. The awareness sensor (100) may include one or more devices that are configured as digital signal processors (140) from respective radar sensors (130). The digital signal processing data output by digital signal processors (140) may be transmitted to a processor (150), where the spatial coordinates of each obstacle in the device's visibility zone may be calculated. In some instances of using virtual PAAs, use of specialized digital signal processing (i.e., specialized “DSP”) to calculate the coordinates of obstacles may be preferred. Although illustrated separately, the functions of the digital signal processors (140) and the processor (150) may be combined in a single device or chip.

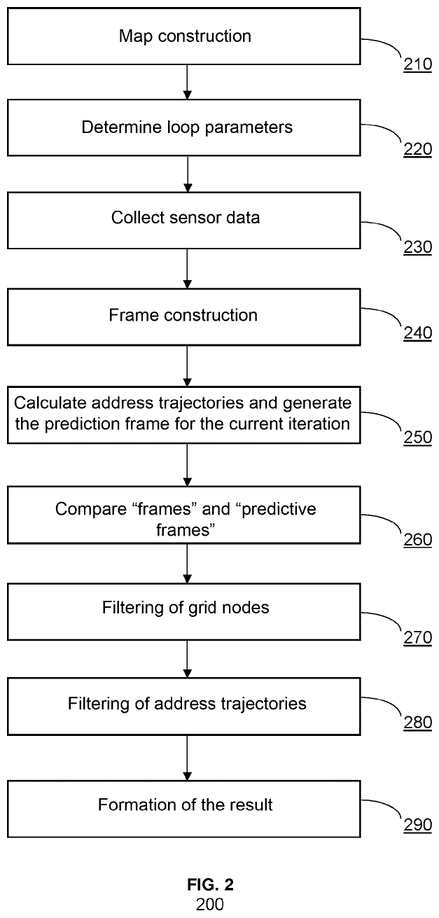

In some implementations, the awareness sensor (100) may additionally include a navigation system (170). Navigation system (170) may be used to obtain data on the movement of the carrier (e.g., in Step 220 of FIG. 2) for determining precise spatial coordinates.

In some implementations, the awareness sensor (100) may additionally include a storage (160) in the device memory. In storage (160) both the data received from the radar sensors (130) and the results of their processing may be stored.

The system diagram of the awareness sensor (100) illustrated is an example and various modifications may be made within the spirit of the invention. For example, the embodiments may be implemented as a separate program that repeats the functions of processor (150) as part of a virtual device that processes data recorded on a storage medium. Additionally, or alternatively, the embodiments may be implemented as a separate program, including the use of specialized processors, such as graphic cards and/or other computing modules of various architectures. In another example, the embodiments may be implemented as embedded software, including for programmable logic (FPGA). In yet another example, the embodiments may be implemented as a separate device or as one of several environmental sensors in a more complex system. In yet another example, the embodiments may be implemented modularly such that data is received from one or several different systems or individual sensors both during the process of receiving information and after the completion of the system's operation.

The embodiments may be readily applied to use various sources of information to obtain data on the platform's movement including, but not limited to, satellite navigation systems, inertial navigation, integrated motion sensors based on Doppler radar, data from photo and video cameras, thermal cameras, wheel position sensors, airspeed sensors, and the like. Additionally, or alternatively, the embodiments may use instead of data on the platform's movement, an analytical function describing the expected trajectory of movement. The platform motion data is collectively referred to as “odometry data.”

Although not shown, the awareness sensor (100) may include a bus and/or other communication mechanism(s) configured to communicate information between the various components of the system diagram, such as a processor, a memory, a database storage, and other storage devices.

In addition, a communication device may enable connectivity between the processor and other devices by encoding data to be sent from the processor to another device over a network and decoding data received from another system over the network for the processor.

The processor (150) may comprise one or more general or specific purpose processors to perform computation and control functions of awareness sensor (100). Processor (150) may include a single integrated circuit, such as a micro-processing device, or may include multiple integrated circuit devices and/or circuit boards working in cooperation to accomplish the functions of processor (150). For example, an ARM-based processing unit may be used alongside Nvidia digital signal processing technologies.

The system may include memory for storing information and instructions for execution by the processor. Memory may contain various components for retrieving, presenting, modifying, and storing data. For example, memory may store software modules that provide functionality when executed by the processor. The software modules may include an operating system that provides operating system functionality for the system. The software modules may further include modules for implementing the functionality of the awareness sensor (100).

Memory may include a variety of computer-readable media that may be accessed by the processor (150). For example, memory may include any combination of random access memory (“RAM”), dynamic RAM (“DRAM”), static RAM (“SRAM”), read only memory (“ROM”), flash memory, cache memory, and/or any other type of non-transitory or transitory computer-readable medium.

Although illustrated as a single system, the functionality of the awareness sensor (100) may be implemented as a distributed system. Further, the functionality disclosed herein may be implemented on separate devices that may be communicatively coupled together. Further, one or more components of awareness sensor (100) may not be included.

FIG. 2 illustrates an example method 200 for determining the precise spatial coordinates of various objects in the visibility zone using a radar device (e.g., radar device's line of sight) with one or more spatially separated pairs of transmitting and receiving antennas. The method 200 consists of sequential steps, which are described below.

In the discussion that follows, a map may describe a coordinate system of a terrain in which each point is described by a set of values, such as (x,yⱼ) coordinates for a flat cartesian coordinate system; and an M map may be characterized by continuous coordinate values. A grid may describe a discrete partition of the map, characterized by a countable set of coordinate pairs (xᵢ,yⱼ) and the value Ψ(xᵢ, yⱼ), determining the probability of the presence of an obstacle at the given coordinates.

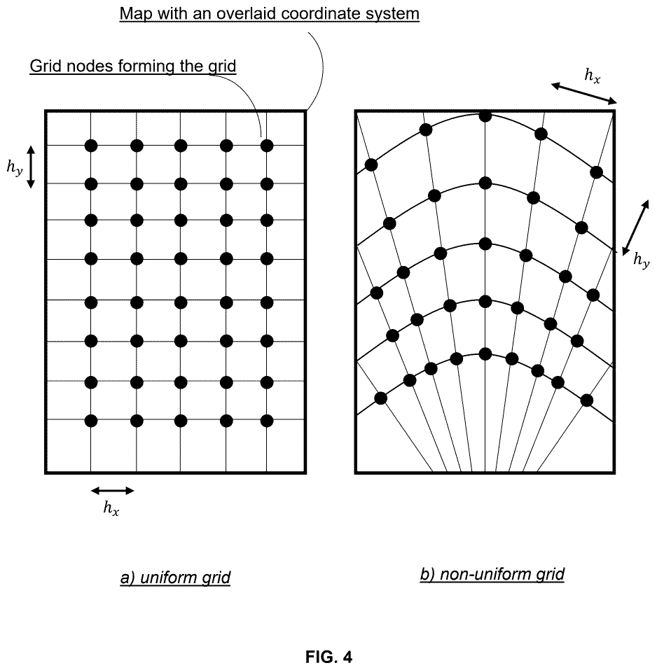

At the initial moment of time, the probability map may be filled with zeros. In a particular case, it is a uniform grid, defined by the following relation:

$${x}_{i} = i \cdot hx , i = - N , … , - 1 , 0 , 1 , … , N \qquad ( 1 )$$

$${y}_{j} = j \cdot hy , j = - M , … , - 1 , 0 , 1 , … , M$$

where: i is the number of grid node along coordinate x; j is the number of grid node along coordinate y; hx is the step of the uniform grid along the coordinate x; hy is the step of the uniform grid along the coordinate y; and N and M are boundaries of the grid area (e.g., the map and the grid thereon illustrated in FIG. 4).

Sensor data is a collection of values describing responses and the distance to them. In the general case, it is described by a countable finite set of triplets of numbers (r,α, p), where r is the distance to the object, α is the angle of deviation from the normal to the object, and p is the complex value of the response (its amplitude and phase, specified as a pair of numbers). The example implementation uses the following definition of sensor data:

$$( {x}_{k 1 , k 2} , {y}_{k 1 , k 2} ) , k 1 ∈ ℕ , k 2 ∈ ℕ \qquad ( 2 )$$

$$( {r}_{i} , {α}_{i} , {p}_{i} ) , i = 1 , 2 , … , P$$

where k1 is the loop iteration number; k2 is the sensor number inside the loop iteration number; (x_{k1,k2}, y_{k1,k2}) is the coordinate of sensor k2, inside iteration k1 at grid nodes; i is the number of the detected target inside sensor data k2, inside iteration k1; P is the number of targets detected by sensor k2, within iteration k1; rᵢ is the distance to the i-th object in meters specified with precision dr; α∈[−π, +π] is the direction angle to object i relative to the OX axis of the map, specified with precision dα; pᵢ=paᵢ+j·pbᵢ, where paᵢ is the real part of the response, pbᵢ is the imaginary part of the response, and j is the imaginary unit.

A frame may be a set or subset of grid nodes, in which the presence of an obstacle does not contradict the sensor data in formula (2). The frame may deliberately contain an excessive number of nodes, and one of aims is the absence of errors-namely, missed targets. The specific method for determining the set of grid points from data in formula (2) may depend on the implementation of the various algorithm and may vary accordingly. In general, a frame is defined by pairs of coordinates and power data:

$$\{ {p}_{i , k 1 , k 2} , {x}_{i , k 1 , k 2} , {y}_{i , k 1 , k 2} \} \qquad ( 3 )$$

A predictive frame is a set or subset of grid nodes in which the location of an obstacle is obtained by calculation. Unlike the frame in formula (3), calculations may be carried out once for each iteration of the cycle and take into account all data from all sensors in the aggregate. Therefore, there may be no dependence on the sensor number in the calculations.

$$\{ {p}_{i , k 1} , {x}_{i , k 1} , {y}_{i , k 1} \} \qquad ( 4 )$$

An address trajectory is a set of grid nodes, but unlike frames in formula (3) and formula (4), the address trajectory may be defined as an interconnected sequence of points for each target over time (i.e., a certain iteration number k1).

$$\{ {x}_{i , k 1} , {y}_{i , k 1} \} \qquad ( 5 )$$

The definitions of frame, predictive frame, and address trajectory may be based on the following considerations. The frame may describe the obstacles visible to the sensors, the address trajectories may illustrate an understanding of how obstacles change over time, and the predictive frame may describe a hypothesis about the location of objects that corresponds to the address trajectories and does not contradict the sensor data.

Odometry data may be a collection of different types of data that makes it possible to determine its position at each iteration of the cycle for each sensor. In the example embodiments, data from inertial navigation systems may be used that directly determine the coordinates of sensors in any space.

$$( {x}_{k 1 , k 2} , {y}_{k 1 , k 2} ) \qquad ( 6 )$$

Here, data formula (6) may be used to generate data formula (2).

In formulas (2)-(6), the same indices i,k1,k2 may be used. These three variables may determine the following: the coordinates of the target in formula (2); the coordinates of the sensor from which the target was registered in formula (6); the corresponding coordinate of the target on the frame in formula (3); whether the target belongs to any address trajectory in formula (5); and the conclusion at the current stage of calculations about the existence of the obstacle on the global map, expressed in a predictive frame formula (4).

Consider the implementation of the example embodiments for a radar sensor with an accuracy of dr=0.1 meters and dα=0.1°, which are typical values for continuous-wave radar sensors with linear frequency modulation of the signal (“FMCW”) and the MIMO technology.

Step 210: Map construction. At this stage, the program settings may determine the boundaries N,M, as well as the grid steps hx,hy. Both quantities may be directly calculated from the range of the sensors and the map resolution. For example, rₘₐₓ=100 meters and resolution dx=0.1 meter may be typical values for radar sensors with FMCW. In the example implementation, the map is built using processor (150) of FIG. 1 once, immediately after the device is turned on. The map and any other data obtained during the execution of the steps are stored in storage (160) of FIG. 1.

$$hx = hy = \frac{dx}{\sqrt{2}} \qquad ( 7 )$$

$$N = M = \frac{{r}_{max}}{h x} \qquad ( 8 )$$

Step 220: Determine loop parameters. At this stage, based on the polling frequency of the radar sensors determined by the sensor manufacturer and the accuracy of the odometry data, the frequency of the cycle may be determined. The proposed implementation of the method uses sensors that may directly provide information about coordinates in the formula (6), and therefore the cycle may be determined by numbering the data packets with the index k2. In an example implementation, the frequency of measurements may provide at least 10 measurements per unit of map resolution, for example 1,000 Hz for a 10-centimeter map and a vehicle speed of less than 100 km/h.

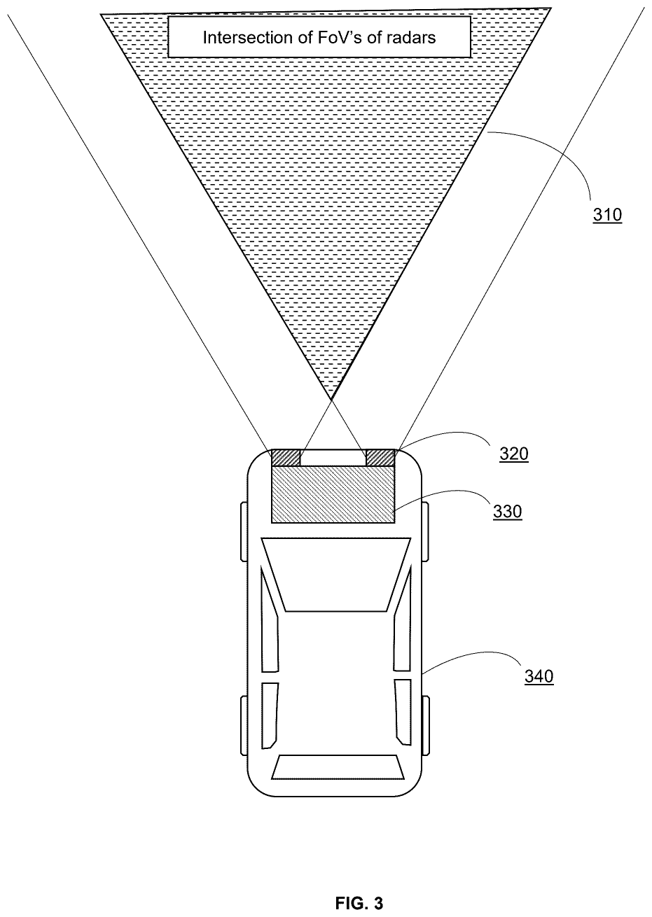

Step 230: Collect sensor data. This step may be carried out by sequentially polling sensors and storing data in the format of formula (2). Sensors based on FMCW radar are capable of providing data in already generated packets corresponding to (2). Thus, when using such devices, no further processing may be required. Otherwise, processing may be carried out in accordance with the instructions for a specific type of sensor. In an example implementation, each of the two radars (e.g., radar sensors 320 of FIG. 3) may transmit a signal and receive an echo signal, calculating the distance and direction to each of the obstacles in the common visibility zone (e.g., an intersecting field of view 310 of FIG. 3).

Here, the MIMO techniques, taking into account the amplitude and phase of the received signal, may analyze the echo signal received by different combinations of the receiving and transmitting antennas, thus forming a virtual directional antenna.

Step 240: Frame construction. At this step, having information in the format of formula (2), it may be converted to the format of formula (3). The difference between steps 230 and 240 may be that in step 230, data is collected in analog form, whereas in step 240, frames are constructed and the collected data are converted by formulas (2) and (3) and input as discrete values of frame coordinates. In the example of implementation, continuous type of data may be data in which directions and coordinates are stored in the memory of the processor (150) in the form of floating-point numbers, while the map may be a coordinate grid with a pre-determined grid step, such as 10 centimeters, for example. Thus, before marking the targets on the map, the processor (150) may quantize the coordinates according to the formulas specified below.

To convert data into the format of formula (3), the rounding principle may be used. Taking into account that the grid step is chosen in such a way as to meet the accuracy requirements, the computationally fastest way to bring the coordinates to a discrete form may be to quantize them and round them to the nearest integer:

$${x}_{i , k 1 , k 2} = round ( \frac{{x}_{k 1 , k 2} + ( {r}_{i} \pm dr ) \cdot cos ( {α}_{i} \pm d α )}{hx} ) . \qquad ( 9 )$$

$${y}_{i , k 1 , k 2} = round ( \frac{{y}_{k 1 , k 2} + ( {r}_{i} \pm dr ) \cdot sin ( {α}_{i} \pm d α )}{hy} ) \cdot hy \qquad ( 10 )$$

where the operator round (*) denotes rounding to the nearest integer.

Here, the target response averaged relative to different types of objects may be used. At this stage, the phase may be determined by the distance to the object. Moving from sensor data to frame data, it may be sufficient to leave only the power information using the following formula:

$${p}_{i , k i , k 2} = {pa}_{i}^{2} + {pb}_{i}^{2} \qquad ( 11 )$$

Note that in formulas (9) and (10) the rounding result depends on the generally random errors caused by the radar sensor (with the accuracies dr=0.1 meters and da=0.1°). Thus, the embodiments utilize expressions (9) and (10) even if the number of points included in the frame increases by a factor of 10× or 100× (e.g., for systems with low angle determination accuracy).

Step 250: Calculate address trajectories and generate the prediction frame for the current iteration. While at step 240, using formulas (9) and (10), several (e.g., from 2 to 1000 with the selected device characteristics) points may be obtained (and marked) for each target on the frame. Assuming that there could potentially be an obstacle at each of the selected grid points, it is necessary to eliminate the extra points. To do this, a predictive frame may be used, which is obtained using a set of data obtained at step k1-1 (i.e., at the previous step).

An intermediate set of frames may be generated {P̅_{i,k1,k2}, x̅_{i,k1,k2}y̅_{i,k1,k2}} according to the formulas

$${dx}_{k 1 , k 2} = ( {x}_{k 1 , k 2} - {x}_{k - 1 , k 2} ) \qquad ( 12 )$$

$${dy}_{k 1 , k 2} = ( {y}_{k 1 , k 2} - {y}_{k - 1 , k 2} ) \qquad ( 13 )$$

$${\overline{x}}_{i , k 1 , k 2} = {x}_{i , k 1 - 1 , k 2} + ⌊ \frac{d {x}_{k 1 , k 2}}{hx} ⌋ . \qquad ( 14 )$$

$${\overline{y}}_{i , k 1 , k 2} = {y}_{i , k 1 - 1 , k 2} + ⌊ \frac{d {y}_{k 1 , k 2}}{hy} ⌋ . \qquad ( 15 )$$

$${\overline{p}}_{i , k 1 , k 2} = {p}_{i , k 1 - 1 , k 2} \qquad ( 16 )$$

where the operator └*┘ denotes taking the integer part.

Formulas (14) and (15), and formulas (9) and (10) in the absence of errors in the system should give identical results. However, in practice, due to random errors in formulas (9)-(10), the frames may differ from each other.

The calculation of formulas (14) and (15) may be further refined by eliminating the coordinates for which there is no response in at least one of the intermediate frames {P̅_{i,k1,k2}, x̅_{i,k1,k2}, y̅_{i,k1,k2}}. This may be easily done by multiplying the corresponding powers.

$${\overline{p}}_{i , k 1} = {\prod }_{k 2} {\overline{p}}_{i , k 1 , k 2} \qquad ( 17 )$$

$${\overline{x}}_{i , k 1} = ⌊ \frac{1}{max ( k 2 ) \cdot hx} {\sum }_{k 2} {\overline{x}}_{i , k 1 , k 2} ⌋ \qquad ( 18 )$$

$${\overline{y}}_{i , k 1} = ⌊ \frac{1}{max ( k 2 ) \cdot hy} {\sum }_{k 2} {\overline{y}}_{i , k 1 , k 2} ⌋ \qquad ( 19 )$$

where the operator └*┘ denotes taking the integer part.

Points with zero power may be discarded and the resulting set is a prediction frame {p_{i,k1},x_{i,k1},y_{i,k1}}

$${p}_{i , k 1} = {\overline{p}}_{i , k 1} , if {\overline{p}}_{i , k 1} > \qquad ( 20 )$$

$${x}_{i , k 1} = {\overline{x}}_{i , k 1} , if {\overline{p}}_{i , k 1} > \qquad ( 21 )$$

$${y}_{i , k 1} = {\overline{y}}_{i , k 1} , if {\overline{p}}_{i , k 1} > \qquad ( 22 )$$

Note that for intermediate frames, odometry data is considered to be known with an accuracy that exceeds the accuracy of radar sensors. In systems where this is not the case, formulas (12)-(16) may have a different form.

It is worth noting that to improve accuracy, it is reasonable to use a sequence of several predictive frames calculated for steps k1-2, k1-3 and so on using formulas similar to (12)-(16).

Set of predictive frames by all values of k1: k1-1, k1-2, k1-3 . . . may form the address trajectory. In some implementations of the method, to simplify calculations in formulas (12)-(19), instead of discrete coordinate values, continuous values are used, and then the address trajectories may be interpolated by smooth curves, which in theory should increase the accuracy of the method.

Step 260: Compare “frames” and “predictive frames”. Assigning statistical probability and overlaying data on a map and grid.

At the current step, based on information about obstacles from the sensors {p_{i,k1,k2}, x_{i,k1,k2},y_{i,k1,k2}} and predictive frame data {p_{i, k1},x_{i,k1},y_{i,k1}}, the set of grid points at which it is possible to draw a conclusion about the probability presence of obstacles in them may be determined.

This conclusion is made from the rationality of the inference that despite the presence of errors in sensor data and difficulties in distinguishing obstacles from each other, the probability of missing a target in a sequence of steps may be significantly lower reliability threshold (for example, p=0.05) and, accordingly, it is derived from the consideration that it is reasonable to assume that there is no obstacle at the grid nodes of the absence of a signal.

In the proposed implementation of the technology, it may be proposed to use the following estimate to express in the formula the ideas embedded in the method. First, points may be eliminated whose signal strength differs significantly from the responses received on other frames. Elimination may be carried out according to a threshold depending on the sensitivity of the sensors and the noise level of the received signals. A typical implementation may use a threshold p=0.05:

$$∀ i , k 2 : {p}_{i , k 1 , k 2} = 0 , if ∃ \tilde{k 2} : {p}_{i , k 1 , k 2} - \leq p \cdot {p}_{i , k 1 , \tilde{k 2}} \qquad ( 23 )$$

After using formula (23), points whose power variability from sensor to sensor exceeded a certain threshold may be removed from consideration.

Considering the complex structure of the radiation pattern of objects, formula (23) makes sense if

$${r}_{i}^{2} >> {( {x}_{k 1 , k 2} - {x}_{k 1 , \tilde{k 2}} )}^{2} + {( {y}_{k 1 , k 2} - {y}_{k 1 , \tilde{k 2}} )}^{2} \qquad ( 24 )$$

Next, a weighted estimate may be made of the proportion of frames in which a reliable signal is present at the current iteration along the grid coordinates. The result may be entered into the current prediction frame. The formula may be normalized to take a value from 0 to 1. The weight coefficient may be selected proportional to the ratio of the current power to the maximum signal power recorded at a given point

$${p}_{i , k 1} = {\sum }_{k 2} {p}_{i , k 1 , k 2} \div {\sum }_{k 2} {p}_{max} \qquad ( 25 )$$

$$where {p}_{max} = {max}_{k 2} ( {p}_{i , k 1 , k 2} ) \qquad ( 26 )$$

Finally, a weighted assessment of the presence of an obstacle at a given point may be carried out based on the last K predictive frames (i.e., based on K points of the address trajectory). The results may be immediately plotted on the grid. The proposed design may use geometric weighting so that older signals contribute less.

$$Ψ ( {x}_{i , k 1} , {y}_{i , k 1} ) = {\sum }_{n = 0}^{K} {2}^{- n} {p}_{i , k 1 - n} \div {\sum }_{n = 0}^{K} {2}^{- n} \qquad ( 27 )$$

Step 270: Filtering of grid nodes. The filtering of grid nodes by a confidence threshold may be carried out by resetting to zero all values not exceeding the threshold p, for example

$$p = 0.95 Ψ ( {x}_{i , k 1} , {y}_{i , k 1} ) = 0 if Ψ ( {x}_{i , k 1} , {y}_{i , k 1} ) \leq \qquad ( 28 )$$

Step 280: Filtering of address trajectories. Filter address trajectories to reduce computational complexity. Those for which the current grid point value is 0 may be excluded from the set of address trajectories.

Step 290: Formation of the result, go to step 230.

To generate the result, the grid Ψ(xᵢ, yⱼ) may be converted into a binary mask for a given iteration k1.

$${\overline{Ψ}}_{k 1} ( {x}_{i} , {y}_{j} ) = \{ \begin{matrix}1 , & if Ψ ( {x}_{i} , {y}_{i} ) > 0 \\ 0 , & if Ψ ( {x}_{i} , {y}_{i} ) = 0\end{matrix} \qquad ( 29 )$$

The value of iteration number k1 may be increased by one and the operations may be repeated starting from step 230.

In some embodiments, computational complexity may be reduced. For example, in order to reduce computational complexity, the responses of targets for which coordinates with the required accuracy have already been obtained may be excluded (i.e., subtracted) from the radar signal. In another example, in order to reduce the computational complexity, when processing frame sequences, spatial coordinates at which the absence of any object has already been confirmed may be deliberately not processed.

In some embodiments of the invention, individual frames may be used to detect the coordinates of moving targets that are moving relative to other observed objects at a constant speed and direction or at variable speeds and directions.

In some embodiments, MIMO-based sensors may be used as radar sensors. In some embodiments, continuous action radars, pulse action radars, or devices of different actions may be used simultaneously. Some embodiments may utilize radar-on-chip formats. In some embodiments, a continuous coordinate system may be used instead of a grid and grid nodes. In some embodiments, when calculating the address trajectory, the error of the radar sensor itself may be taken into account and probability distribution functions may be used instead of the exact coordinates of objects.

FIG. 3 illustrates an example of the installation diagram of an awareness sensor (330) with two radar sensors (320) on a vehicle (340). The arrangement of the antennas and an example of the placement of the awareness sensor (330, element 100 in FIG. 1) on the vehicle are illustrated in FIG. 3. In this example configuration, the awareness sensor (330) itself may include two radars sensors (320) with an intersecting field of view (FoV) (310). In some configurations, the radar sensors may be movable relative to each other. Instead of a car (340), various types of mobile platforms may be envisioned, manned and unmanned. The embodiments may be executed within the spatial area described by the intersection of the fields of view of the transmitting and receiving antennas (310). Here, FIG. 3 shows the positioning of the operational area relative to its installation location.

FIG. 4 illustrates a schematic illustration of a coordinate system called a map and variant arrangements of grid nodes on it. In particular, FIG. 4(a) illustrates use of a uniform grid; and FIG. 4(b) illustrates use of non-uniform grid in a polar coordinate system recommended for use with a sensor that detects more than one coordinate.

As shown, FIG. 4 illustrates the spatial positioning of points where the embodiments enable obstacle detection. Based on the physical dimensions of the obstacle, the grid steps hx and hy may be selected. For example, the grid steps may use the resolution provided by the radar sensor along the range coordinate, i.e., the accuracy with which the sensor determines the distance to the obstacle).

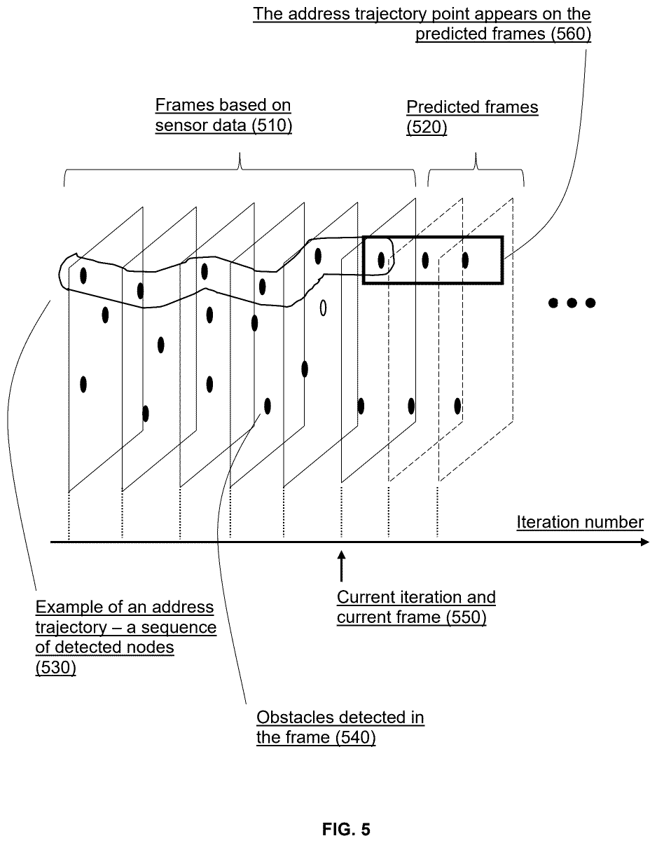

FIG. 5 illustrates a relationship between the frames, predictive frames and address trajectories generated during the operation.

Frames generated based on sensor data (510) illustrate information about obstacles (540) and their distance, obtained from each of the radars used. The embodiments may enable the identification of signals on different frames as belonging to the same physical object. This association may be illustrated by a set of coordinates collectively referred to as an address trajectory (530). In some configurations, the embodiments enable tracking of echo signals obtained by different sensors from a single obstacle. These spatial tracks may be stored in memory as sets of coordinates and are called “address trajectories.”

By using frame data and address trajectories, through analysis of the current frame (550), to determine predictions about the expected radar data in the future. This prediction, represented as a set of object coordinates at each moment in time, may collectively form a set of predicted frames (520). Based on the set of address trajectories and frames obtained at a given point in time, the embodiments may calculate the expected set of echo signals likely to be received by radar sensors in the next few seconds. These “most likely sets” may be called predicted frames (520).

By comparing predicted frames (520) stored in the address trajectory memory (530) with data continuously received from the radars, a complete list of obstacles and their coordinates within the invention's field of view (560) is generated. Additionally, by comparing the set of predicted frames and the actual radar data, a map of the surrounding area may be generated.

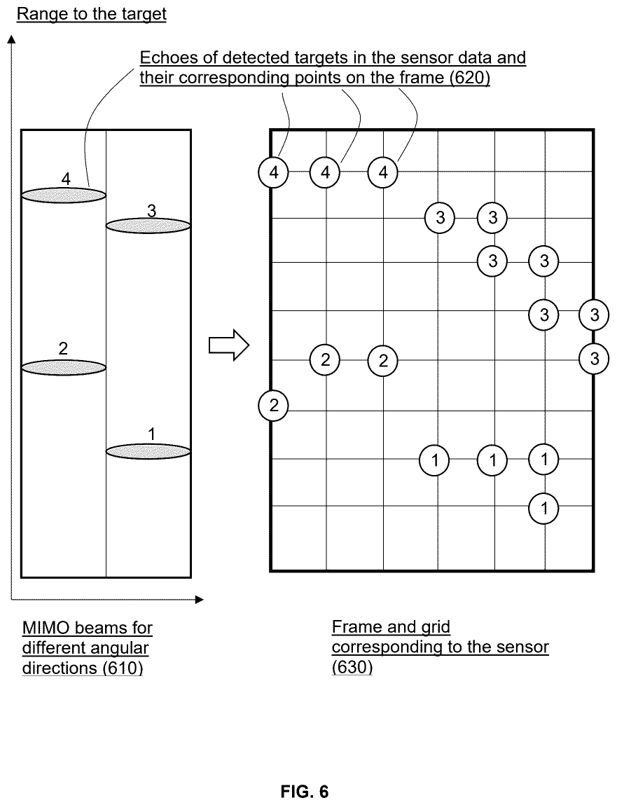

FIG. 6 illustrates sensor data obtained from one sensor and the result of forming a frame from the sensor data.

Signals from targets in such a sensor (610) may be represented as sets of distances to obstacles in multiple (at least two) spatial directions, determined by the configuration of the device's transmitting and receiving antennas. Echo signals obtained by a typical MIMO radar sensor may be represented by digital arrays of detected obstacles and measured distances to them. The number of arrays may correspond with the number of beams formed by the MIMO radar (i.e., at least two).

In operation, the sensor data may be represented as points located at grid nodes (630). For this, each obstacle detected by the sensor (620) may be marked on multiple grid nodes along the direction and range determined by the radar. The actual coordinates in the Cartesian system may be calculated using these arrays and the spatial positioning of beams provided by the sensor manufacturers. Nodes in the grid (630) that could potentially contain an obstacle may be marked.

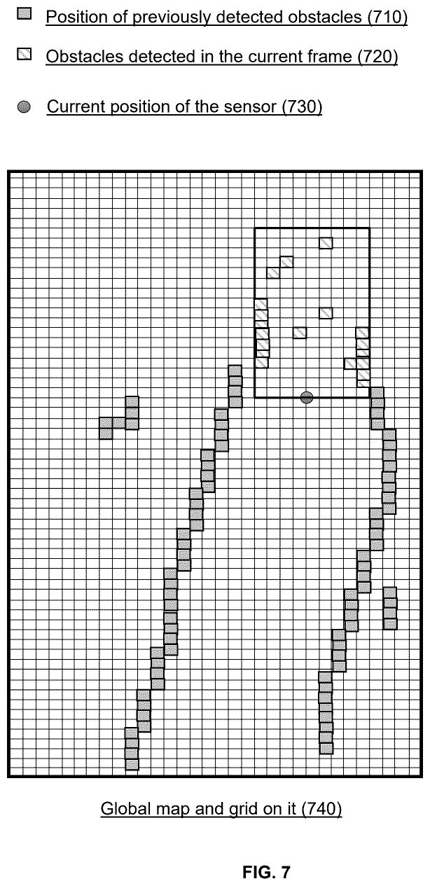

FIG. 7 illustrates an example of combining frame data and grid data in the process of generating a global map. The illustration shows obstacles (720) that are within the current field of view (730). Using data of global coordinates and the coordinates of previously detected obstacles (710), all obstacles may be mapped onto the global map (740).

The various embodiments may be used both to create a map within the radar's field of view and to construct a global map in the process of solving the simultaneous localization and mapping (SLAM) problem. To build a global map, once the coordinates of obstacles are obtained, they may be transferred into a global coordinate system via the navigation module (i.e., navigation system 170 of FIG. 1). The embodiments may integrate with real-time SLAM systems, enabling enhanced navigation capabilities capable of processing radar signals in real-time, which is crucial for autonomous driving and robotic applications where quick decision-making is necessary.

In the foregoing, the embodiments may be used in radar devices (independent of the type of modulation and the wavelength of the radiation) designed to determine the coordinates of objects in the field of view of the transceiver antenna relative to the radar device. Thus, the embodiments may be fully or partially implemented in devices in which a unique type of modulation is used in each virtual antenna. The embodiments may be used both for systems that determine only one object coordinate (e.g., distance to the object) and several coordinates (e.g., range and angular coordinates or object coordinates in the general terrain coordinate system).

As described herein, the general principle of forming a virtual PAA and devices implementing it for calculating the spatial coordinates of obstacles may be introduced. The introduction of a MIMO-based radar sensor enables the obtaining of both the range to the observed object and its angular coordinates relative to the sensor itself. The angular coordinates may be calculated by comparing signals received from different spatially separated pairs of receiving and transmitting antennas (Virtual PAAs).

Thus, two main problems may be solved by the embodiments of the present invention. First, the embodiments may be less susceptible to noise such as the presence of interference noise in the signal (so-called “speckle noise”). Therefore, suppression of signals arising from multipath interference effects may be achieved. The multi-beam interferometry suppression property may be achieved by setting a limit on the minimum distance traveled to confirm the coordinates of an object. This distance may be at least twice the radar correlation radius, which is determined by the wavelength, the platform speed, and other factors. Second, the embodiments may be more accurate for determining coordinates of an obstacle even at greater distances. The accuracy of the obtained coordinates does not depend on the distance to the observed object.

By implementing the embodiments, an additional result is the possibility of generating a system for determining the spatial coordinates of objects using radar devices that measure only one coordinate (i.e., the distance to the object). This result may be achieved when using several, at least two radar sensors located on one platform and spaced apart in space by a known amount. In addition, this result may be achieved due to double accumulation of the signal. Here, the embodiments may utilize the movement parameters of the platform on which all radar sensors are installed.

Accordingly, the embodiments may provide a radar vision sensing system and may be integrated with automotive radars, advanced driver assistance systems (“ADAS”), and autonomous vehicles. The embodiments may integrate radar technologies with data processing methods that improve radar accuracy and performance, particularly for automotive and robotic applications (e.g., robotic transportation systems, robotic passenger taxis, robotic freight and last-mile delivery systems, container terminals, etc.). In addition, the embodiments may integrate with a variety of sensors such as LiDAR, cameras, and global positioning systems (“GPS”).

By implementing the embodiments, the target detection may be enhanced and false positives are reduced. For example, the embodiments may improve accuracy by about 210% for long-range and 133% for short-range applications compared to traditional techniques. These improvements may be achieved even without additional segmentation or filtering, demonstrating robust performance in detecting expected obstacles. Additionally, the embodiments may effectively manage noise and target separation issues prevalent in traditional MIMO systems. Thus, by implementing the embodiments of the invention, radar accuracy may be improved and expensive LiDAR systems may be substituted with more cost-effective radar solutions.

It will be apparent to those skilled in the art that various modifications and variations may be made in the systems, devices, methods and instructions for determining the location of one or more observed objects of the present invention without departing from the spirit or scope of the invention. Thus, it is intended that the present invention cover the modifications and variations of this invention provided they come within the scope of the appended claims and their equivalents.

1. A method for determining spatial coordinates of an object in a visibility zone using a radar device with one or more spatially separated pairs of transmitting and receiving antennas, including:
receiving at least one dataset from at least one radar sensor, including an object response and coordinates of at least one pair of transmitting and receiving antennas; and
calculating one or more address trajectories for spatially distributed points that form a grid in relative coordinates; and
comparing frames sequential or synchronously received frames from one or more radar sensors to determine the coordinates of the object.

2. The method according to claim 1, wherein the object is detected in real-time.

3. The method according to claim 1, wherein the dataset is received from the at least one radar sensor in the form of a set of recorded analog-to-digital converted (“ADC”) data.

4. The method according to claim 1, wherein the dataset received from the at least one radar sensor includes information about a speed of movement of the object.

5. The method according to claim 1, wherein the dataset received from the at least one radar sensor includes information about a speed of movement of the platform.

6. The method according to claim 1, wherein a probability map of the object is stored in a non-transitory memory.

7. The method according to claim 1, wherein the at least one radar sensor is movable relative to another radar sensor during operation.

8. The method according to claim 1, wherein the dataset is used to obtain odometry data.

9. A device that determines spatial coordinates of an object in a visibility zone using a radar device with one or more spatially separated pairs of transmitting and receiving antennas, including:
a non-transitory memory; and
a processor that:
receives at least one dataset from at least one radar sensor, including an object response and coordinates of at least one pair of transmitting and receiving antennas;
calculates one or more address trajectories for spatially distributed points that form a grid in relative coordinates; and
compares frames sequential or synchronously received from one or more radar sensors to determine the coordinates of the object.

10. The device according to claim 9, wherein the object is detected in real-time.

11. The device according to claim 9, wherein the dataset is received from the at least one radar sensor in the form of a set of recorded analog-to-digital converted (“ADC”) data.

12. The device according to claim 9, wherein the dataset received from the at least one radar sensor includes information about a speed of movement of the object.

13. The device according to claim 9, wherein the dataset received from the at least one radar sensor includes information about a speed of movement of a platform.

14. The device according to claim 9, wherein a probability map of the object is stored in the non-transitory memory.

15. The device according to claim 9, wherein the at least one radar sensor is movable relative to another radar sensor during operation.

16. The device according to claim 9, wherein the dataset is used to obtain odometry data.

17. A radar vision sensing system comprising:
at least one radar sensor configured to detect objects within a predefined range; and
a processing unit operatively connected to the at least one radar sensor, the processing unit being configured to execute a method comprising:
receives at least one dataset from the at least one radar sensor, including an object response and coordinates of at least one pair of transmitting and receiving antennas;
calculating one or more address trajectories for spatially distributed points that form a grid in relative coordinates; and
comparing frames sequential or synchronously received from one or more radar sensors to determine the coordinates of the object.
